(19) United States
(12) Patent Application Publication
(10) Pub. No.: US 2018/0107455 A1
(43) Pub. Date: Apr. 19, 2018

(54) REAL-TIME COLLABORATIVE DEVELOPMENT IN A LIVE PROGRAMMING SYSTEM

(71) Applicant: Eyelead Software SA, NEA IONIA (GR)

(72) Inventor: IOSIF PSISTAKIS, ATHENS (GR)

(73) Assignee: Eyelead Software SA, NEA IONIA (GR)

(21) Appl. No.: 14/981,982

(22) Filed: Dec. 29, 2015

(51) Int. Cl. G06F 8/30; G06F 8/34; G06F 9/445; H04L 29/08

(52) U.S. Cl. CPC G06F 8/30; H04L 67/10; G06F 9/44521; G06F 8/34

(57) ABSTRACT

Improved techniques for real-time collaborative development in an authoring system, especially suited for the production of multimedia applications and games, are described. In an exemplary embodiment, collaborative live development involves: (i) loading digital resources of a structured binary format in a host device that manages synchronization and versioning, (ii) establishing a communication session between the host device and a client device, (iii) synchronizing digital files of a structured binary format between the client device and the host device using devices similar to Source Control Management systems, and (iv) incorporating any resource changes in the Live Programming execution environment in a non-intrusive manner on the basis of predefined criteria.

### TECHNICAL FIELD

The present invention relates generally to the creation and generation of multimedia entertainment applications, more specifically to authoring systems for software applications and games with an emphasis in 3D content.

### BACKGROUND

The rise of available computing power has triggered a rise in demand for rich software applications. From video games to digital media consumption, applications are becoming more sophisticated, regardless of the computing platform. To develop such applications, developers deploy a collection of tools, generally referred to as authoring systems or integrated development environments. Some authoring systems connect over a computer network environment to provide, for example, file access, file sharing, and/or file management services to their users. Such services are often needed in production teams, for the creation of digital media or the authoring of applications.

Team members often need to exchange multiple, large-volume digital files, each submitting their work at different points in time during production. Conventional authoring and content management systems—due to their non-interactive, complex and technically burdensome nature—ultimately prevent developers from maximizing their creativity, and from fully collaborating with one another n an efficient manner.

With the introduction of “cloud based” services and source code repositories, collaborative development is better facilitated. “Cloud” technologies seamlessly connect users to network resource. They automatically generate appropriate network endpoints and balance server load to provide optimal experience.

Another important development is Live Programming environments. Such environments allow developers to load and execute the a set of source code files, then make significant changes to the program's code and automatically and seamlessly load and execute them without resetting the application under development. The execution environment preserves all pertinent program information (the execution state) and changes only parts of the code that have been modified by the developer. This is particularly beneficial because it reduces time spent on trial-and-error executions, i.e. the time it takes the developer to test their implementation of a supposed solution to a problem.

The current state of the art offers industry standard mechanisms for synchronizing code files, connecting to other devices via the cloud and for sensing whether a file has changed. Those mechanisms are employed by the proposed invention to address an issue arising from implementing collaborative development techniques in Live Programming Authoring Systems.

### BRIEF DESCRIPTION OF THE DRAWINGS

FIG. 1 shows an exemplary VFile (Virtual File) structure. VFiles are generalized in-memory data containers, functioning as structured resource representations.

FIG. 2 shows an exemplary Project Structure. Projects contain collaboration and application related information, including application development settings, team member settings as well as transient information related to locked files and real-time collaboration permissions.

FIG. 3 shows a generic execution device environment wherein the Live Programing Authoring System is stored and executed.

FIG. 4 shows a normal set up for two-person collaboration. Two client devices (“Authoring System 1” and “Authoring System 2”) are connected with a shared repository via the network.

FIG. 5 shows a flowchart for the Live Programming workflow, whereas the authoring system incorporates code changes to the execution environment interactively. This system is not collaboration optimized.

FIG. 6 shows a flowchart for a Collaborative Live Programming system. The Live Programming workflow s adjusted to support fast, real-time collaborative development.

FIG. 7 is an example graphical user interface (GUI) generated by client side modules of an authoring system according to an exemplary embodiment.

FIG. 8 is an exemplary overview of the proposed workflow, showcasing the various actors and devices in a Live Programming team collaboration setup.

### SUMMARY

The present disclosure is directed to improved techniques for real-time collaborative development in a cloud-based or server-based development system with Live Programming features. In contrast to other systems, the proposed system aims to facilitate real-time team collaboration over a Live Programming environment. This approach provides major benefits in multimedia application and games development, but finds broader uses in general programming.

It is generally understood that modern software applications contain two significant parts: a code part, which describes the logic of an application in a set of programming language, commonly edited by manipulating texts files; and a content part, which contains the various media elements, be it audio, video, images, 3D object representations or other media representations. It is also generally understood that due to complexity and skill requirements, applications are normally developed by teams of individuals. Each individual developer may implement a different aspect of the application, including a code aspect or a content aspect. The individual developers need to exchange data and share their edits in developing the application, in a process normally referred to as collaboration.

The exemplary embodiment device presented herein ensures that team collaboration can take place transparently to every individual developer, without causing disruptions in any developer's workflow, be it a code development or content development scenario. At the same time, it allows for on-line and off-line collaboration on both text-based media (code, text) and binary media representations. This is achieved by leveraging the current state of the art, using well-known techniques for detecting whether a file has changed, for automatically mapping network endpoints, for synchronizing file parts via a shared repository and for merging changes between alternative versions of files.

More specifically, the proposed device implements Live, Collaborative development of an application in a network-enabled environment. The term “Live” implies that changes (edits) on any element of the application being developed are instantly reflected into the application currently executed once the user initiates a “save” operation. The term “Collaborative” implies that changes (edits) in any element of the application being developed are integrated automatically or semi-automatically to a shared team repository, which represents the jointly developed product and accordingly disseminated to other team members.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The detailed description set forth below in connection with the appended drawings is intended as a description of exemplary embodiments of the present invention and is not intended to represent the only embodiments in which the present invention can be practiced. The detailed description includes specific details to provide a thorough understanding of the exemplary embodiments of the invention. It will be apparent to those skilled in the art that the exemplary embodiments of the invention may be practiced without these specific details.

While the embodiments will be described in the general context of program modules that execute in conjunction with an application program that runs on an operating system on a computing device, those skilled in the art will recognize that aspects may also be implemented in different configurations and combinations with different modules. Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, programmable consumer electronics, mainframe computers and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process or processes. The computer-readable storage medium can for example be implemented via one or more of a volatile computer memory, a non-volatile memory, a hard drive, a flash drive, a floppy disk, or a compact disk, and comparable storage media. Moreover, the computer-readable storage medium can be implemented as a network-based repository, allowing transfer of the computer program to a memory device via a computer network.

Throughout this specification, the term “platform” may be a combination of software and hardware components for managing collaboration services in a networked environment, where embodiments may be implemented. Examples of platforms include, but are not limited to, a hosted service executed over a plurality of servers, an application executed on a single server, and comparable systems. The term “server”, “host”, and/or “host device” or the like generally refers to a computing device executing one or more software programs typically in a networked environment. However, such a device may also be implemented as a virtual device software program executed on one or more computing devices viewed as a computer on the network.

In some instances, well-known structures and devices are shown in block diagram form, in order to avoid obscuring the novelty of the exemplary embodiments presented herein.

Conventional Workflow Operation

A conventional methodology for collaboration and data exchange over the network is the exchange of “files”. A file is generally understood to mean a chunk of digital data located in a storage device and typically managed under the control of a file management device. Such management devices include operating system devices known as File Systems. File Systems use common conventions to create, delete, access, alter, edit and otherwise manipulate files. Under operating system control, files can be replicated and transmitted over a network. The File System does not concern itself with the structure of the data contained in a file; with the exception of File System-specific information (metadata), all other data are left unprocessed by the operating system. The files themselves exist in long-term memory, or on virtual devices that simulate long-term memory, otherwise they cannot be managed by the File System.

To edit the contents of a file, the user (developer or artist) must first “load” the file into memory. This process involves a specific editing program parsing the binary contents of the file and creating a properly arranged data structure in volatile computer memory. All edits happen in that data structure. At any given time, the user must perform a “save” operation, converting the volatile data into a properly formatted binary representation, suitable for long-term storage within the File System. In practice, with every “save” process, a new file is essentially created and stored in place of the old one in the File System.

Because users are required to work on volatile-memory copies of files, this poses problems with maintaining the File System integrity, especially in relation to collaboration scenarios. By way of example, let us consider the case of a shared file where two users, A and B, “load” the same shared file in memory and separately do edits in the memory representations of the file. When user A “saves” the file, the shared file will be representing the edits made by user A, as his system will save its memory contents of its editor application to that file. However, when user B eventually “saves” her work, any edits user A performed will be destroyed: By the “save” operation, user B duplicates her own editor's memory data on that shared file. However, her editor s unaware of any edits by user A, and as such, all edits by user A are lost. This situation is a “write conflict” and prohibits collaboration.

Modern file systems have two methods to prevent write conflicts. In a first method. When a user signifies that they will open a file for “editing”, the File System “locks” that file, restricting permission to other users. This constrains editing to one user at a time. In a second method, some File Systems provide access to previous versions of a shared file, which allows preservation of changes. This allows users to open previous versions of the file and thus retain some of the changes.

Both mechanisms have severe pitfalls. The first approach works efficiently only when there are only few, sparse edits to a file, without the need for it remain open in an editor for long periods. When a shared file is required to remain under editing for a long time, other team members may be locked out and wait for access to that shared file for too long in the process to be efficient. The more developers waiting in line to get access to a locked shared file, the more inefficient the process becomes. The second approach allows users to be working on a shared file at the same time. However, to the extent the changes of User B and the earlier changes of User A cannot be automatically merged. Any merging of changes would need to be done manually by User B immediately after they have finished their one work, assuming that User B has identified the changes. For text-based files there are industry standard technologies to automatically merge historical changes. For binary media representations, there is no automated system for merging changes.

A possible method for collaborative editing is screen sharing. In the screen share approach, collaborators are given access to a common Graphical User Interface (GUI). Any remote user's graphical input is relayed through the network. An application relays mouse and keyboard events from each collaborator and these events are translated into edit commands. This approach is practical only in occasional and rudimentary user exchanges, typically support or presentation-type scenarios. This method is very impractical for development because it requires that all collaborators view the same objects and work on a single item at a time.

Application developers are familiar with concurrent version control systems. Such systems allow developers to perform changes to a common code repository in an off-line manner, modify code files, and test edits locally. Whenever a developer submits changes, the differences from the repository version are found and incorporated into the repository. A special parser manages editing conflicts by taking into account the internal data structure that each file represents. The problem with such systems is they are not compatible with particular media files, such as image, 3D data, and audio media files. Concurrent version control systems are the industry-standard system for text files written in the more popular programming languages.

Live Programming systems introduce further workflow issues when used in conjunction with Version Control Systems. Because Live Programming preserves the state of the software during code re-integration (the process of replacing currently running code with edited code when the developer saves a code file), Live Programming systems can easily handle code changes in real time. However, Version Control Systems normally work in stages, or turns, where a developer downloads a snapshot of the code repository, then performs edits for a long period (typically hours or days) and then performs a “merge” operation, integrating their edits to the common repository. This staged approach discourages collaboration in real time. Moreover, because downloading a snapshot of the code repository happens in a single step, it is highly likely that the Live Programming system will require the user to reload the code in its entirety, because of the number of changes introduced. As such, whenever a developer needs to contribute to the common code repository or integrate edits from the repository, they will be required to stop using the Live Programming system. For specific workflows, including game development, multimedia application development and agile development, this constraint is highly problematic and creates severe barriers to creativity.

By resolving the issues above, collaboration can also be greatly simplified. By allowing automated synchronization of media and code resources, it is possible to provide live feedback of all development operations as they happen, in real-time, or near real-time. This is especially beneficial for game development, agile teams, multimedia application development and rapid prototyping scenarios.

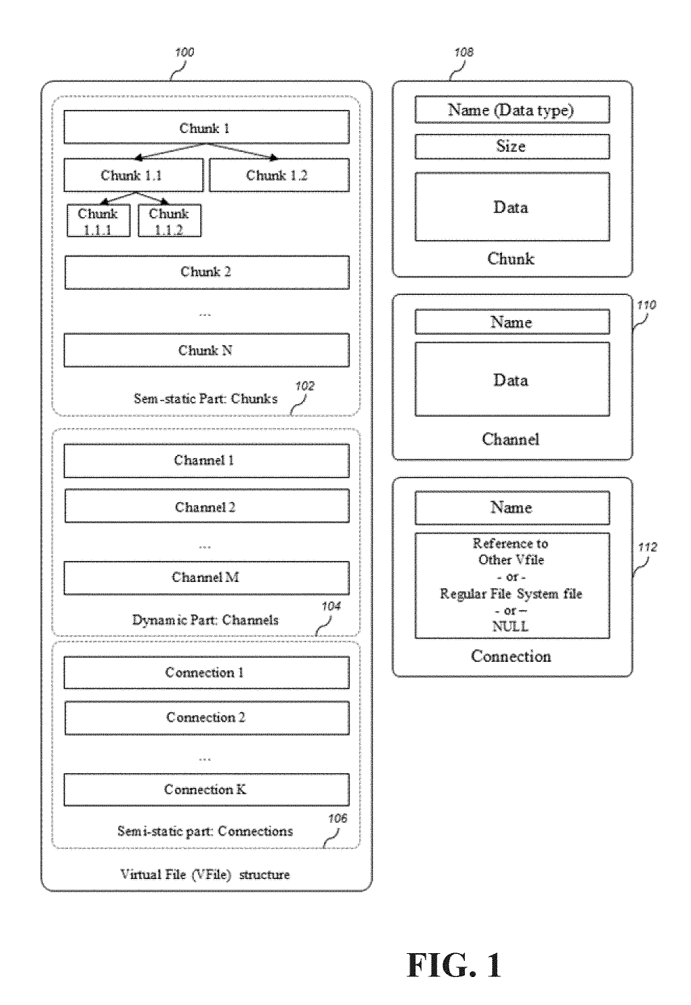

FIG. 1 shows an exemplary VFile (Virtual File) structure in accordance with an exemplary embodiment. VF les are generalized in-memory data containers, functioning as structured resource representations.

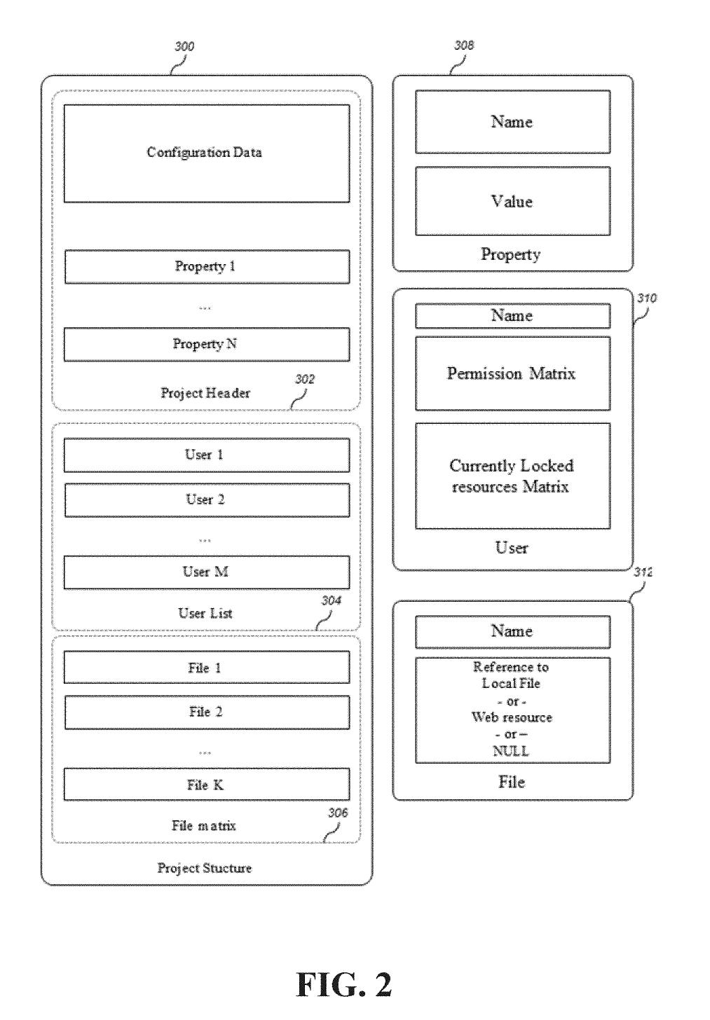

FIG. 2 shows an exemplary Project Structure. Projects contain collaboration and application related information, including application development settings, team member settings as well as transient information related to locked files and real-time collaboration permissions.

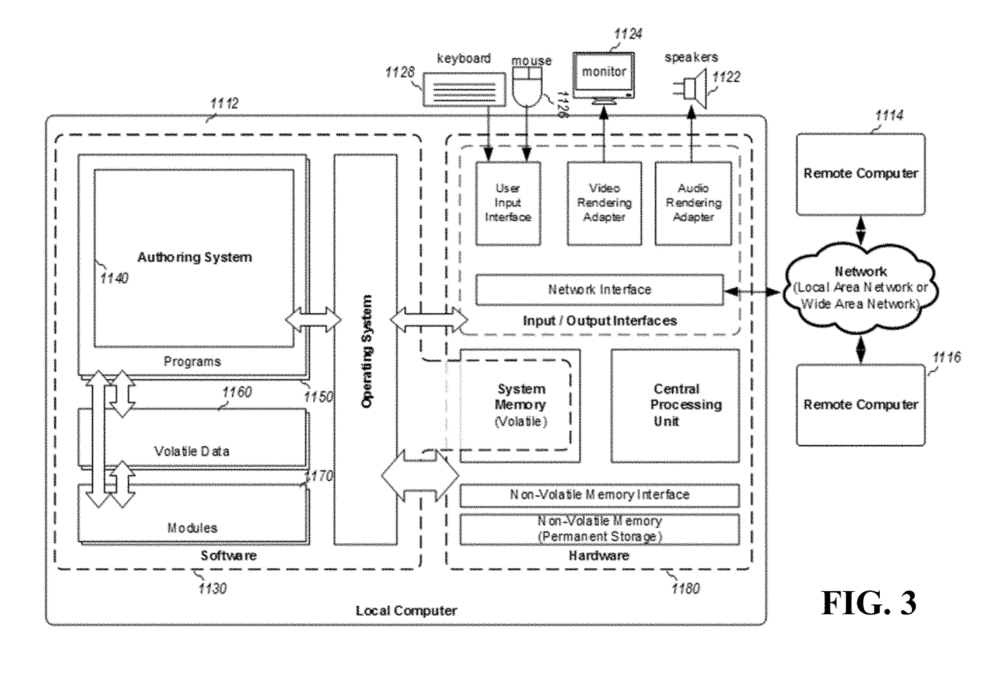

FIG. 3 shows a generic execution device environment wherein the Live Programing Authoring System is stored and executed.

The present invention aims to optimize and streamline team collaboration in Live Programing development systems, where live feedback of other team members' work outcomes is both possible and highly desired. Relevant Authoring Systems applications include web-development authoring environments, game-development authoring environments and cross-platform software application integrated development environments.

The Authoring Systems described herein are themselves Software Applications residing and executed within a computing system (FIG. 3), and are comprised of a Software 1130 and a Hardware 1180 part. The Authoring System 1140 exists as a digital medium (program) and is loaded into volatile memory by the computing system for execution. It then loads resources from various sources, including long term storage, non-volatile memories and network interfaces into volatile memory as data representations. To achieve data exchange the Authoring System manipulates hardware devices to connect to networks and establish communication with remote devices 1114,1116, including server computers and other client devices, communicating with properly programmed Authoring System counterparts residing and executed within the remote devices

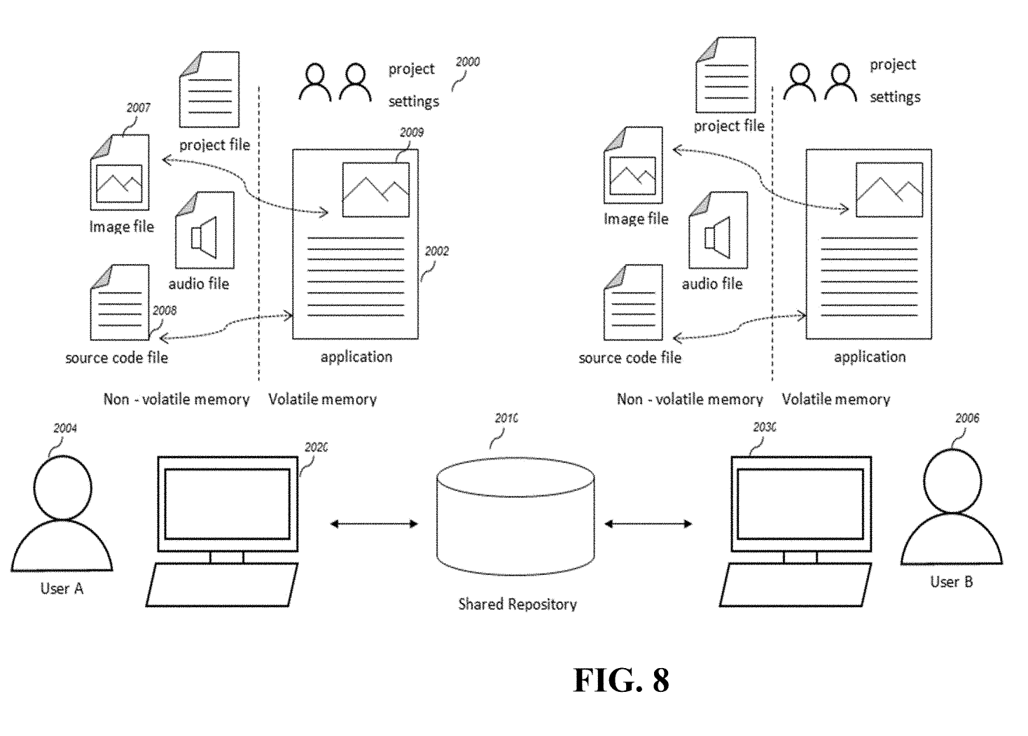

In the exemplary embodiment, an overview diagram of which is described in FIG. 8, an improved collaborative authoring system is described. The system allows team-based collaborative development, both off-line and in real-time. More specifically, the proposed authoring system allows users to develop content and code media representations of any supported type, concurrently or in a staged fashion; also to exchange code and content files in a way similar to Version Control Systems if required.

The collaborative authoring system approach, as envisioned, automatically synchronizes data, in volatile (system) memory as well as in the file system, as described in detail below. The proposed approach integrates two synchronization devices: (i) an off-line system, akin to the Concurrent Version Control system, but with the added ability to synchronize supported binary file formats; and (ii) an on-line real-time collaboration system designed to synchronize in-memory data during collaborative editing sessions. The underlying mechanisms, algorithms and program routines are common between the two systems.

Implementation of Live Programming

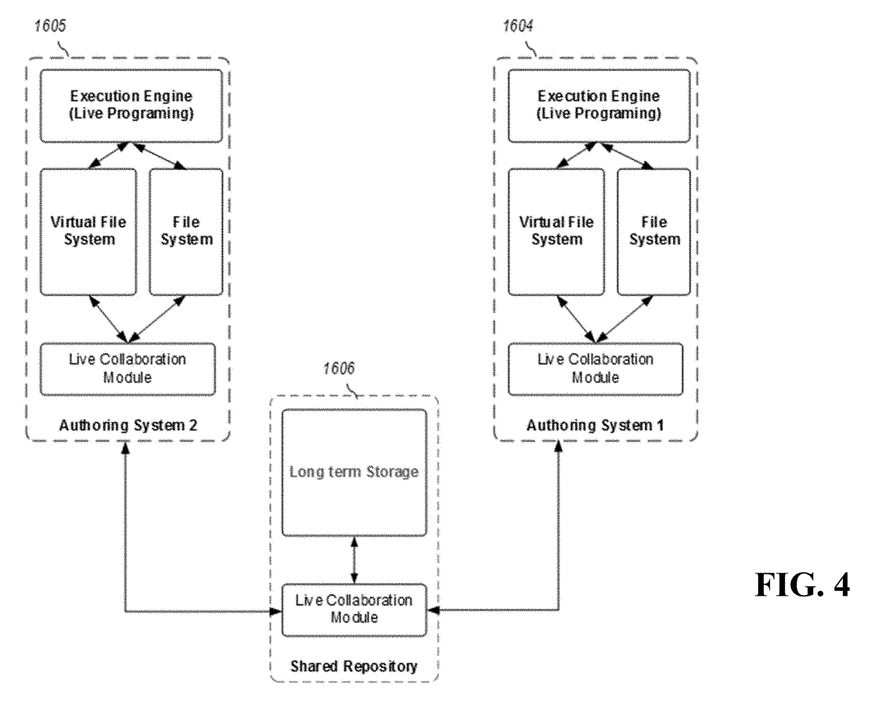

FIG. 4 shows a normal set up for two-person collaboration. Two client devices (“Authoring System 1” and “Authoring System 2”) are connected with a shared repository via the network.

As depicted in FIG. 4, the envisioned approach, proposes that the Authoring System (AS) be further extended with a network-based Live Collaboration Module (LCM). The Authoring System is a Live Programming Authoring system. Further to standard development systems, it also:

1. Allows developers to manipulate various visual, aural, 3D data or other media related to the application under development, also allowing insertions and deletion of such media from the File System;

2. Allows developers to integrate code files in the system, as special media objects and accordingly edit those files;

3. Provides an execution framework for the application, by executing the application's code in real time and presenting the results to the user n real time

4. Senses external and internal changes in media and code files in the File System and automatically reintegrates those files in by reloading them whilst preserving the state of the application.

To achieve this functionality, the Authoring System (1140) employs two central concepts: VFiles 100 and Projects 300, (see FIG. 1, FIG. 2). VFiles are structured in-memory resource representations of the various media currently presented to and edited by a user. The term VFile is shorthand for Virtual Files, not to be confused with the normal files that exist in an Operating System's File System. VFiles encapsulate data of any type, but in structured manner, n contrast to the abstract binary manner of a regular File System file. Projects groupings of files that may not be currently in memory, but are relevant to the Application, the Team and the Common Repository. The LCM automatically synchronizes all File System files in the Project, giving high priority and special treatment to files that are currently loaded in the Live Programming environment and being edited.

At any given moment, the authoring system programs (1604, 1605) are connected to a host computer system that manages the shared code and content repository 1606. That computer host system executes a part of the Authoring System that focuses on data relay and file storage. The executed software is a properly configured LCM. For the exemplary embodiment, the Authoring System Host (1606) is a cloud-based set of server devices. Other implementations may be server-less, distributed, with each client also acting as a host system, or local network-oriented.

Projects define network endpoints for team members, allowing them to connect to a common code and content repository. Whenever a Team Member access a file or makes edits to the file (or the corresponding VFile), the LCM marks that file as being edited by that specific Team Member and (if connected to a network host system) signals other LCMs attached to the Project via the network accordingly. Whenever a change is transmitted to the host system to update the shared Code and Content repository, the Team Member that performed the change is also marked.

VFiles allow the Authoring System to encapsulate any type of information in a uniform and manageable structure, which on can be used for real-time collaboration. VFiles are mapped to media objects of the Application being developed. Furthermore, VFiles may be mapped to specific regular File System files, be it media containers or code containers. During Live coding, whenever a change happens in any of the media items of the application, this change is reflected on a corresponding VFile. Because VFiles are structured, this change can be expressed in specific parts of the VFile and as such, it can be catalogued and transmitted over the network to other collaborative editing clients, if necessary. Adversely, whenever a File System file is changed (1704), the changes will be automatically reflected to the corresponding VFile and by extension to the media object of the Application being executed/developed. Most importantly, because a VFile can be mapped to a Non-Volatile storage file, VFiles streamline the “save” process, allowing multiple users to open a specific File and still keep their edits synchronized, through their network.

When a file is loaded as a corresponding VFile in the memory of a local computing device, the Authoring System retains the internal structure of the VFile, However, when edits occur, the LCM marks each individual area of the VFile to indicate when, which edits have been made to that data and by whom. In the following, we shall define the relevant marking data of that area as “editing metadata”. Editing metadata facilitate off-line synchronization in situations where network connection is unavailable or there are stalls in the network relay system. While attached to the network, only the editing metadata along with the changed parts of a VFile are transmitted.

Whenever a user (developer) on the client (local workstation) edits a VFile (in-memory), that VFile needs to be validated. Validation means that the client ensures that the post-edit resulting VFile is valid and does not cause any issues in the project. The edit is then propagated to the host. The host in turn notifies all other clients that a content update is available. Any connected client will then individually decide whether to incorporate the update in real-time or not. When the affected VFile is “loaded” in memory, the update is updated directly in the VFile. When, on the other hand, the affected VFile is not “loaded” in memory, it is marked as available for off-line synchronization and is synchronized with a lower priority.

Implementation of Collaborative system.

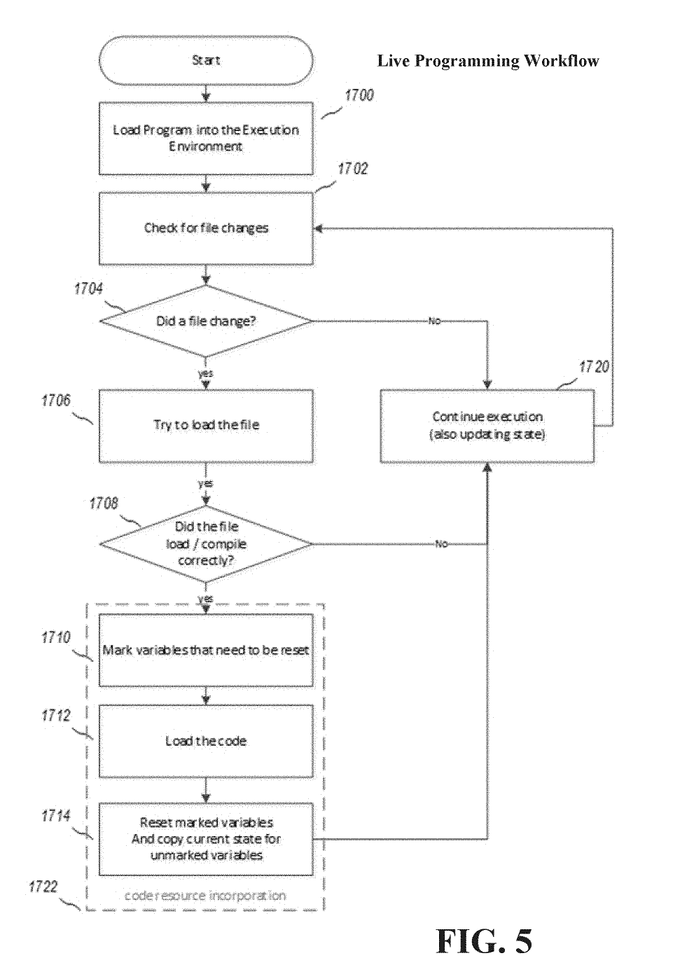

FIG. 5 shows a flowchart for the Live Programming workflow, whereas the authoring system incorporates code changes to the execution environment interactively. This system is not collaboration optimized.

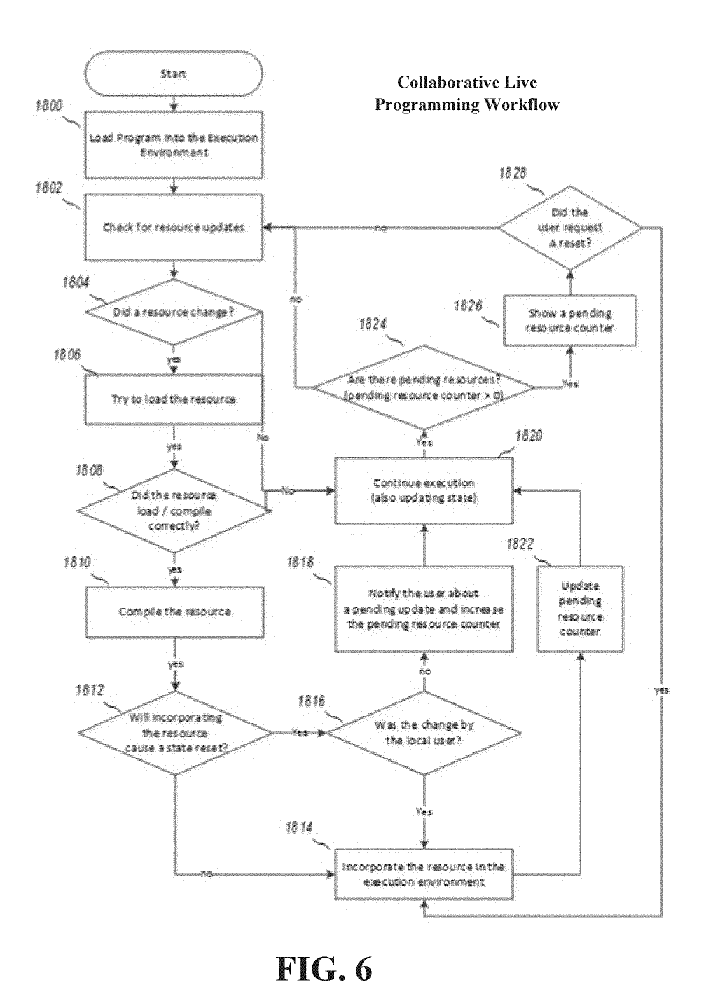

FIG. 6 shows a flowchart for a Collaborative Live Programming system. The Live Programming workflow is adjusted to support fast, real-time collaborative development.

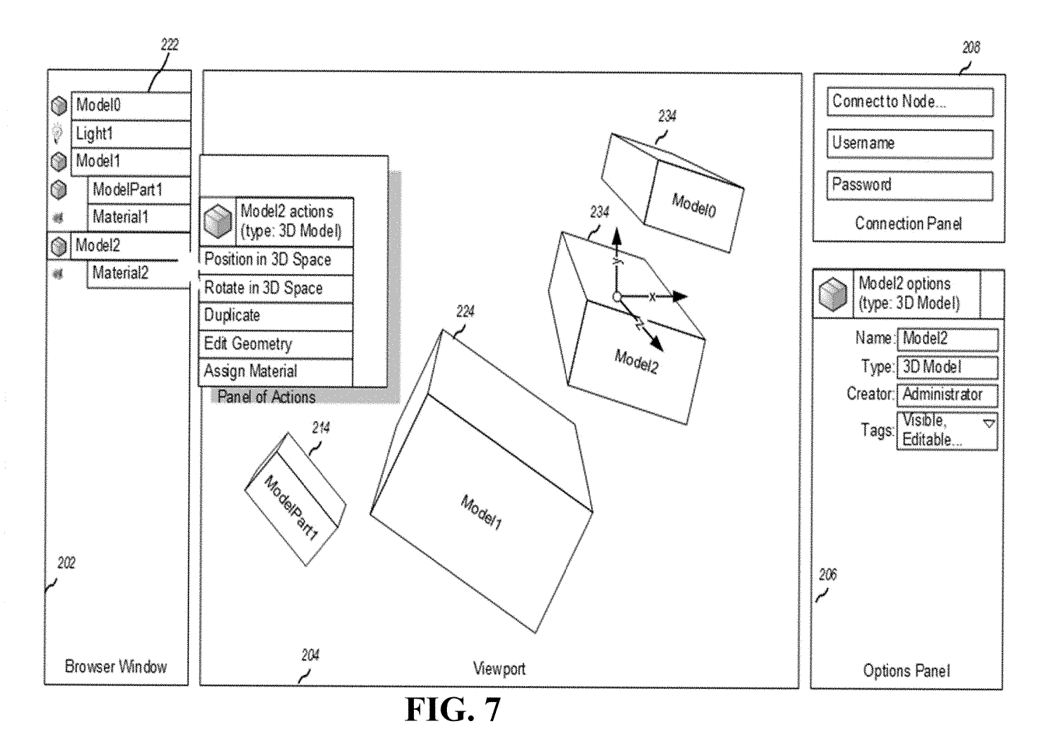

FIG. 7 is an example graphical user interface (GUI) generated by client side modules of an authoring system according to an exemplary embodiment.

FIG. 8 is an exemplary overview of the proposed workflow, showcasing the various actors and devices in a Live Programming team collaboration setup.

Referring to FIG. 6, a Live Programming mechanism suited for real-time collaboration as proposed herein is provided. VFiles containing code are given special consideration.

In a Live Programming system there is a situation where, when a user changes a code file and that code file is automatically propagated across the network to the host, problems can arise with other team members. This is because in Live Programming systems, whenever there is a change in the code file, the Live Programming system takes all necessary steps to reflect that change in the code. Changes by other users, loaded in the Live Programing Authoring System, will cause changes in the state of the program that are not expected by the user.

More specifically, when a file is changed by a user and loaded in the Live Programming Authoring System 1706, the system tries to preserve the state of the program being executed three outcomes are possible once the new version of the code is loaded:

1. If the new version is compatible to the previous version and the user has not altered any initial values, the state will be preserved and the new code will appear to run seamlessly in the Live Programming Authoring System.

2. If the new version is compatible, but the user has changed initial values or has created new variables (see 1710), the Live Programming system will reset the state of the variables to reflect the change in the code, because it will assume that the user wants to taste the new initial value. As such, the transition to the new code will be accompanied by a reset of the state of some variables

3. If the new version is incompatible with the old version, i.e. if too many variables have changed to the point that the system cannot be preserved, the system will have to reset the state of the new code as it is being loaded 1714.

All three outcomes above would be acceptable outcomes in a Live Programming system. The user understands the constraints of the system when editing a code file and expects occasional resets for edits they have performed themselves. However, the system during collaboration updates a file, incorporating changes by a third user, outcomes 2 and 3 are unacceptable. Since the user has not explicitly changed the code for those files, they expect the software to be running smoothly. Any resets in the execution should happen only with the user's consent.

The proposed invention resolves this issue by making a distinction by changes done locally and changes done remotely 1816. When a code file is being edited locally in the Live Programming system, any change is loaded and implemented immediately by the system. However, for code files that have been changed by other team members and are updated through the shared code and content repository, those files are loaded only if they can be loaded smoothly 1812, without state resets. The local user s then notified (by a counter system—1824) that if he or she performs a manual program state reset, code updates will be loaded.

The technique proposed above manages to synchronize all changes on a shared repository automatically, without disrupting the work of any individual team member. To implement this technique, the system implements a validation scheme after compiling a code file and before loading the compiled code into the Live Programming execution system. The validation scheme consists of the following steps.

1. The updated code file must compile successfully in order to be further processed by the system (1808). This applies to any other media representation, in the sense that the system will

2. To load the uploaded file, check if loading will require a state reset (1812)

3. If the file can be loaded without any state resets, proceed with loading (1814)

4. If the file cannot be loaded without any state resets but is a file edited by the local user, proceed with loading (1816)

5. Otherwise, if the file cannot be loaded without disrupting the user and that file was changed by a remote team member, hold off the loading and notify that there is a code update pending (1818).

To implement this technique, the proposed invention employs the VFiles (Virtual Files) concept, as an encapsulation of the state and compiled code for every associated code file. All objects related to the code that is associated with a specific VFile are stored and managed by that VFile. As a whole, they are that VFile's state. Furthermore, the VFile contains information about elements such as:

1. Variable definitions

2. Function definitions

3. Current value of every pertinent code variable

4. Initial values for code variables

The elements above describe a code file's state set. Whenever a code file is compiled, the pre-existing state set of the code file, stored in the associated VFile and currently in execution, is transferred to the compiled code. However the following changes in the state cannot be mapped and will require the state set to be reset partially (some objects will need to be deleted or set to their initial value) or totally (all objects will need to be deleted or set to their initial value—see 1722).

1. A change in the initial value of a global or static object

2. A change of the type of a specific object, unless the existing state set object can be cast to a new type

3. A change of the internal structure (new type definition) of a type of an object in the code.

The LCM first compares the state set definitions of the existing and the to-be-loaded code. It can then predict whether a state reset will be required and decide on whether to load the code (local changes) and perform the reset, or to hold off loading (remote changes) until the user performs a manual code reset.

Handling Concurrent Changes to the Same Content

When two users concurrently edit the same resource (code or content, represented in a VFile or regular file) in different workstations, there is an edit conflict and the resulting collaborative outcome can be erroneous. This is because if the same part of the content has been altered in different ways, it may be impossible for the system to merge those edits. It is possible, however, that alterations have been made in different parts of the content, or that both sides have performed the same modifications to the content. In any case, the resulting outcome is considered an editing conflict and a system exists to sense and resolve such conflicts.

The proposed invention employs two mechanisms to handle edit conflicts. First, it employs a signaling system to notify team members about which Project files are currently being edited and/or synchronized and thus to discourage concurrent edits. Second, it uses the editing metadata to resolve and conflicts arising by concurrent edits. Because edits are synchronized regularly on a VFile bases, such conflicts are expected to be rare.

When the host system delivers an update (performed by a remote user) on a shared resource also being edited by the user, a “merge changes” mechanism is deployed. This mechanism inspects both alternative versions (the remote and the local alternative) and implements a third version that combines (merges) all editing operations, then loads that file into the Live Programming system. Depending on the type of media that a VFile encapsulates, there are several possible outcomes.

1. If the resource is source code or text, changes can be merged using industry-standard techniques. Using the timestamp information, the system can understand which parts of the files are common. If there are still conflicts, a manual merge process is initiated: a conflict resolution screen is provided to the user, and differences between versions are displayed, as is the industry standard for code management systems.

2. If the resource is a non-textual medium, the system can use a per-segment timestamp on the changes of each alternative versions. It uses that information in an effort to merge all changes in the two alternatives, i.e. by creating a new version that combines the most up-to-date chunks of both edits. A manual merge is also possible: The user can pick specific parts of each of the two alternative versions and create a new merge version.

Once the merge process is complete, the resulting resource is then loaded to the Live Programming environment and presented to the user. At this point, the user s presented with the choice to keep the merge or retry the merge by bringing up the manual merge screen. During that process, all other team members are notified that access to that resource and the associated file is restricted as a new version is being created and edit conflicts are being resolved.

The embodiments described above are intended to illustrate aspects of the invention and modifications, variants and equivalents such as would be readily apparent to the skilled person are encompassed within the scope of the invention such as defined, for example, by the claims.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or n a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. In a client computing device, a method of live editing the source code and content of a software application or digital medium by a first user while a second user s live editing the source code and content of the same software application or digital medium on a second remote device, comprising the client computing device implemented method of:
loading resources as structured in-memory representations where the representations are shared between edit and play modes of operation;
associating corresponding content files as part of the software application or digital medium being editing via a Project grouping data structure;
further associating team members, roles and permissions as part of a Project grouping data structure; and
executing the application defined by the structured in-memory representations while the contents of the representations are being edited by a first user, then, once the editing operations are finished, loading the edits into the executed application to reflect those edits while preserving the state of the application to avoid unnecessary reloads.

2. The method of claim 1, further comprising a mechanism for synchronizing data via a Shared Network Resource that also stores Project Information.

3. The method of claim 2, further comprising locking a structured in-memory resource representation in response to the request to alter that resource.

4. The method of claim 3, where the alteration of a first structured in-memory resource representation includes altering a property of that representation and automatically triggers the capture of Editing Metadata, including the time of alteration, the altering user and the segments of the in-memory representation affected.

5. The method of claim 4, where the altering of a property of a first structure in-memory resource representation is transmitted to the Shared Network Resource along with its Editing Metadata.

6. The method of claim 5, where additional users including the Second User are attached to the Shared Network Resource for data exchange and synchronization.

7. The method of claim 6, where the Shared Network Resource, upon receiving an update message regarding the alteration of a first structured in-memory resource representation along with its editing metadata, it stores that alteration, transmitting the alteration along with its editing Metadata to all attached client devices except the originating client device.

8. The method of claim 5, where a client device senses a change in a source code element of the application from the user controlling the client device and immediately loads and executes that modified source code resource ensuring that:
the state of the running application is preserved, thereby minimized reload times;
any changes in the code are properly displayed, including changes to initial values of variables; and
any required actions, including a reset in the executed application state happen immediately upon loading.

9. The method of claim 5, where a client device senses a change in a source code element of the application, originated from the Shared Network Resource and compares the current execution state with the modified element's state set requirements, then decides, based on that comparison immediately loading that source code resource so, deeming that it is safe to do so, or refrain from loading.

10. The method of claim 5, where whenever a structured in-memory resource representation is locked, the lock instruction is also automatically transmitted to the Share Network Resource and from there propagated to all attached client devices to the Shared Network Resource, as dictated by the Project definition.

11. The method of claim 5, where a client device is attached to a Shared Network Resource after a loss of connectivity, thereby
receiving all updates to structured in-memory resource representations from the Shared Network Resource since the time of loss of connectivity;
applying all updates to structured in-memory resource representations; and
transmitting all the catalogued edits (including Editing Metadata) that it has not transmitted since loss of connectivity.

12. A non-transient computer readable medium containing program instructions for live editing code and content on a client device of a software application or digital medium by a first user while a second user s live editing code and content on the same software application or digital medium on a second remote device, the instructions including:
loading resources as structured in-memory resource representations in a memory where the structured in-memory resource representations are shared between edit and play modes of operation;
associating corresponding content files as part of the software application or digital medium being editing via a Project grouping data structure;
further associating team members, roles and permissions as part of a Project grouping data structure; and
executing the application defined by the structured in-memory resource representations while the contents of those representations are being edited by a first user, then, once the editing operations are finished, loading the edits into the executed application to reflect those edits while preserving the state of the application to avoid unnecessary reloads.

13. The non-transient computer readable medium of claim 12, further comprising an instruction to synchronize data via a Shared Network Resource that also stores Project information

14. The non-transient computer readable medium of claim 13, further comprising an instruction to lock a structured in-memory resource representation in response to the request to alter that structured in-memory resource representation.

15. The non-transient computer readable medium of claim 14, further comprising an instruction to automatically capture Editing Metadata for a structured in-memory resource representations (including the time of alteration, the altering user and the segments of the representation affected), whenever the system detects a change in the representation being edited.

16. The non-transient computer readable medium of claim 15, further comprising an instruction to automatically transmit an update message to the Shared Network Resource along with pertinent Editing Metadata whenever the altering of a property of a first structured in-memory resource representation.

17. The non-transient computer readable medium of claim 16, further comprising an instruction for the Shared Network Resource, to store an alteration and retransmit it along with pertinent Editing Metadata to all attached client devices except the originating client device, whenever it receives an alteration update message.

18. The non-transient computer readable medium of claim 17, further comprising an instruction to a client device, that whenever it senses a change in a source code element of the application from the user controlling the client device it will immediately load and executes that modified source code resource ensuring that:
the state of the running application is preserved, thereby minimized reload times;
any changes in the code are properly displayed, including changes to initial values of variables;
any required actions, including a reset in the executed application state happen immediately upon loading.

19. The non-transient computer readable medium of claim 18, further comprising an instruction to a client device, that whenever t senses a change in a source code element of the application, originated from the Shared Network Resource, to compare the current execution state with the modified element's set requirements and then decide, based on that comparison immediately loading that source code resource so, deeming that it is safe to do so, or refrain from loading until the local user explicitly commands it, so as to avoid a possible execution state reset.

20. The non-transient computer readable medium of claim 18, further comprising an instruction to disable local editing capabilities but present the software application being developed as an independent software application.
